(19) United States
(12) Patent Application Publication
(10) Pub. No.: US 2015/0256010 A1
(43) Pub. Date: Sep. 10, 2015

(54) PORTABLE ELECTRONIC DEVICE AND ASSOCIATED DOCKING ASSEMBLY WITH MAGNETIC CHARGING, SWITCHING AND DATA TRANSFER

(71) Applicant: JAYBIRD, LLC, Salt Lake City, UT (US)

(72) Inventor: Marco Scandurra, Miami Beach, FL (US)

(73) Assignee: JAYBIRD, LLC, SALT LAKE CITY, UT (US)

(21) Appl. No.: 14/638,950

(22) Filed: Mar. 4, 2015

Related U.S. Application Data
(60) Provisional application No. 61/948,014, filed on Mar. 4, 2014.

(51) Int. Cl. H02J 7/00

(52) U.S. Cl. CPC H02J 7/0044; H02J 7/0031; H02J 2007/0039

(57) ABSTRACT

A portable electronic device comprises at least one low-profile electrically conductive magnets, each working as an electrical contact and a mechanical locking element requiring no additional parts such as pins or springs. The magnets can be located anywhere—and independently of each other—on the external housing of the portable device. By virtue of the magnetic attractive force, they attach firmly to an associated docking assembly with mating magnets of opposite polarity. The docking assembly can be a power cable, a desktop charging station or another portable device such as a tablet or smart phone. When mating magnets come into contact the device is mechanically secured to the docking assembly and transfer of electrical charge and data can be enabled. A simple optional circuitry coupled to the magnets enables power on/off switching functions without mechanical push buttons.

### CROSS-REFERENCE TO RELATED APPLICATIONS

This application claims the benefit of U.S. Provisional Application No. 61/948,014 filed on Mar. 4, 2014, which is incorporated herein by reference in its entirety.

### TECHNICAL FIELD

The present disclosure relates generally to mobile and wearable devices and with battery charging, power switching and data transfer for portable devices.

### BACKGROUND OF THE DISCLOSURE

Portable electronic devices are shrinking in size due to advances in semiconductor science and manufacturing. Mobile phones, tablets, smart watches and other wireless products such as Bluetooth headsets require increasingly smaller electric connectors to enable battery charging, and data transfer. In response to this demand, compact electric connectors such as micro-USB and Apple Inc.'s Lightning Connector have been invented. However, these connectors are still relatively bulky; for instance in a Bluetooth headset the micro-USB port occupies a significant portion—up to 20% or more—of the entire volume of the device. Shrinking the USB connector further poses mechanical stability and durability problems. Indeed smaller electrical pins and thinner support plastic make the part prone to deformation and fracture due to mechanical stresses. A traditional electrical connection relies on mechanical pressure and a spring-like mechanism to lock a “male” plug into a “female” receptacle. While this is a simple method, applying pressure and forces through manipulation can cause the plug to deform or fail. Inventors Rohrbach et al. tried to address this challenge by introducing a magnetic connector disclosed in U.S. Pat. No. 7,311,526; here, an electrical plug is proposed comprising a strong magnet positioned near or around a plurality of conventional cylindrical pins. The magnet mates with another one of opposite polarity positioned in a target receptacle. When the magnets are brought into proximity the connector locks firmly due to the magneto-static attraction between magnets without the need for mechanical pressure. A moderate force is sufficient to unplug the connector before excessive stresses and fatigue build up and damage the part.

Other magnetic connectors have been proposed in U.S. Pat. Nos. 8,478,912 and 8,449,304. In addition, various designs for such devices are set forth in U.S. Pat. Nos. D639,748 and D629,752. U.S. Pat. No. 7,658,613 discloses a magnetic socket and plug with a rotary mechanism to align magnets of opposite polarities thereby enabling locking and unlocking with an elegant rotation of the plug. Additionally, U.S. Pat. No. 7,331,793 discloses a connector with a multiplicity of inductively magnetized pins (non-permanent magnets) used as signals for data transfer. The pins have the shape of elongated cylinders and transmit data using magnetic induction (without physical contact) requiring a magnetizing current. In this design, the magnetic pins do not contribute significantly to the attractive force due to the small cylindrical mating area, instead the bulk of the force is provided by dedicated permanent magnets positioned on the side of the connector. The latter however do not contribute to power or data transfer or charging. This set-up makes the connector ingenuous but complex, large and costly. In summary all patents quoted above implement protruding terminals or pins of some sort which have a small cross-sectional area (insufficient for magnetic forces) and which occupy a non-negligible cumulative volume (a “forest of pins”). Indeed this design is not effective when the linear dimensions of the mobile device become comparable with the dimension of the pins.

### BRIEF SUMMARY OF THE DISCLOSURE

Embodiments of the present disclosure are directed toward a battery powered portable device and an associated docking assembly. The portable device may comprise an exterior housing or case. In some embodiments, it comprises a multiplicity of low profile magnets having a relatively large area and small thickness. These low profile magnets are also referred to herein as “magnet-pads.” The device comprises a circuit board and a battery enclosed in the housing. A dedicated battery charging integrated circuit (IC) or power management IC might be mounted on the circuit board. Each magnet carries an electrical signal and is connected either to a terminal of the printed circuit board or to the battery or to both. The connection might be secured either through soldering or through bonding with a conductive compound. In case of soldering the magnets are composed of a thermally stable alloy capable of withstanding solder re-flow temperatures, such as Samarium-Cobalt rare earth magnets. A low temperature re-flow solder, for instance one that is Indium based, can be implemented. If bonding is chosen, Neodymium-based magnets can be implemented (these are capable of withstanding continuous temperatures up to 70 degrees Celsius without demagnetizing).

The magnets can have any shape as long as they are relatively flat. In some embodiments, they are electroplated with one or more electrically conductive thin layers such as Ni—Cu—Ni, Silver or Gold. These metals wet rare-earth magnets producing strong layers that adhere to the substrate, and possess a sufficiently low resistivity thereby enabling good charge and signal transfer upon physical contact with another conductor. Some magnets conduct electricity even in their bulk although not as well as, silver nickel, copper or gold. The magnets conduct electricity to and from the circuit board and generate a magnetic force that is sufficiently large to firmly secure the portable device to the docking assembly. To perform charging functions, one magnet on the portable device is connected to the ground signal of the circuit board and the another magnet is connected to either the battery's positive terminal or to the charging pin of the charging integrated circuit. More magnets can be present on the housing of the portable device to enable power on/off switching functions—as described below—or to enable analog or digital data transfer to and from the portable device. The docking assembly has a head or receptacle comprising a number of magnet pads whose shape and polarity is chosen as to mate with the magnets on the portable device. The docking assembly might have and additional standard connector such as a USB or Lightning Connector to enable docking to a computer or to another mobile device. The docking assembly may have a power adapter connector to enable charging via wall outlet.

Other features and aspects of the disclosed method and system will become apparent from the following detailed description, taken in conjunction with the accompanying drawings, which illustrate, by way of example, the features in accordance with embodiments of the disclosure. The summary is not intended to limit the scope of the claimed disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 is a drawing of a pair of wireless headphones and docking assembly with basic magnet configuration for battery charging.

FIG. 2 is a drawing of a pair of wireless headphones with two magnet pads for secure docking and charging.

FIG. 3 is a drawing of a pair of headphones with one magnet and one ferrous plate for secure docking, charging and power on/off switching.

FIG. 4 is a schematic representation of the reed switch breaking circuit used for powering up and powering down the wireless headphones.

FIG. 5 is a drawing of a pair of wireless earphones comprising four magnets per earphone, said magnets being used for charging, secure docking, power on/off switching and data transfer.

FIG. 6 is a circuit schematic showing an alternative method for powering up and down a pair of wireless headphones using magnets and a voltage regulator with enable pin.

FIG. 7 depicts a wireless stereo headset with magnets, wherein one earphone is oriented horizontally and the other vertically to enable electrical shorting of the magnets for powering down the device.

FIG. 8 is a partial view of the docking assembly showing the head in a four magnet configuration.

FIG. 9 is a partial view of the docking assembly of FIG. 8, with a pair of wireless earphones attached through the magnets for charging, and/or data transfer.

FIG. 10 illustrates an example computing module that may be used to implement various features of the systems and methods for estimating sky light probes disclosed herein.

### DETAILED DESCRIPTION

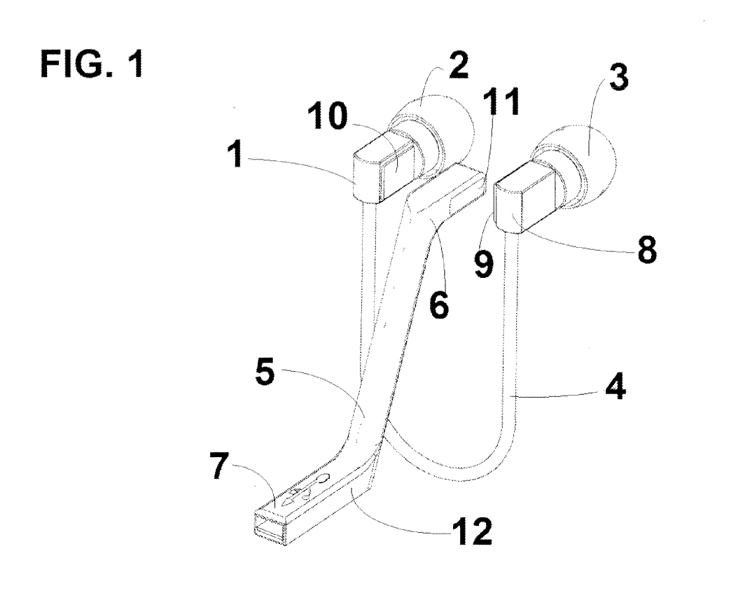

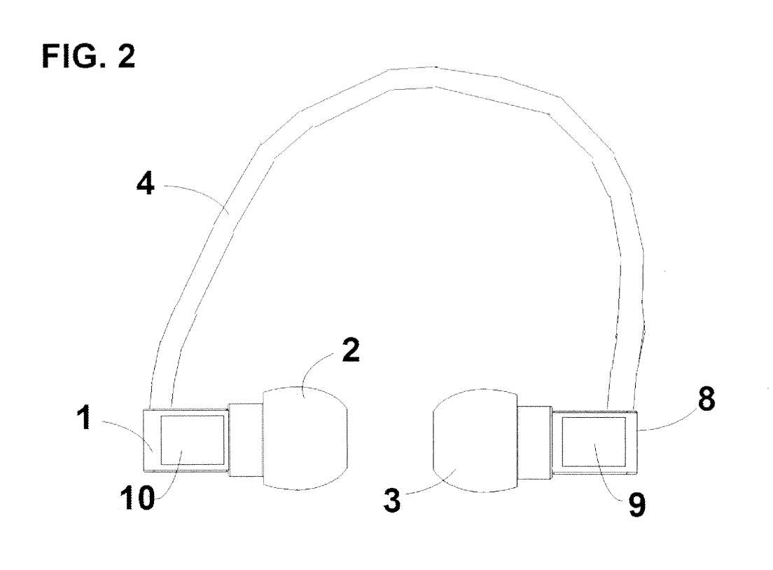

One embodiment is depicted in FIG. 1. Here the portable device 1 consists of two wireless stereophonic earphones 2 and 3 (such as for instance Bluetooth compatible) joined through a cable 4. The docking assembly 12 comprises a cord 5, a head 6 and a connector 7. The latter can be a standard USB compliant connector, a micro-USB or any other connector that allows charge such as Apple Inc.'s Lightning Connector. The earphones 2 and 3 comprise a housing (or case) 8, and two rare earth magnet pads 9 and 10. The head of the docking assembly also comprises two rare-earth magnet pads, one of which is visible in this drawing as element 11, the other being positioned on the left hand side of the head 6, opposite to the first. The magnets polarity is opposite to that of the mating magnets 9 and 10 in order to generate an attractive force. A detailed view of the same portable device 1 is shown in FIG. 2 where magnet pads 9 and 10 are better visible. Magnet pad 9 is connected to the ground signal of the internal circuit board; magnet pad 10 is connected to the positive charging pin of the charging IC. Magnets 9 and 10 can be chosen to have the same polarity N,N or S,S, so that they repel and do not come into contact accidentally shorting the ground and charging pin. However, magnets 9 and 10 may have opposite polarity, provided a shutdown and/or over-current protection circuitry is integrated within the internal circuit board. The advantage of having opposite polarity is that the earphones can firmly attach to each other when not in use making the device more compact.

In FIG. 1, the magnets mounted on the head of the docking assembly are internally connected to the ground and the positive voltage supply pins of the USB connector 7 respectively by means of cable 5. When earphones 2 and 3 touch the sides of the head, they attach firmly to it in virtue of the magnetic attractive force. In addition, when connector 7 is plugged into a computer (not shown in the figure) or another mobile device such as a cellular phone or tablet computer, the internal battery of the earphone begins to charge. The author of the present disclosure found in the course of trials that Neodymium magnet pads of N50 grade and 0.5-millimeter thickness, plated with Ni—Cu—Ni provided an optimal mechanical force and electrical conductivity enabling charge at several hundred milliampere without overheating. The size of the magnet pads can range between 5 and 15 millimeters, but other sizes are possible without departing from the scope of this disclosure.

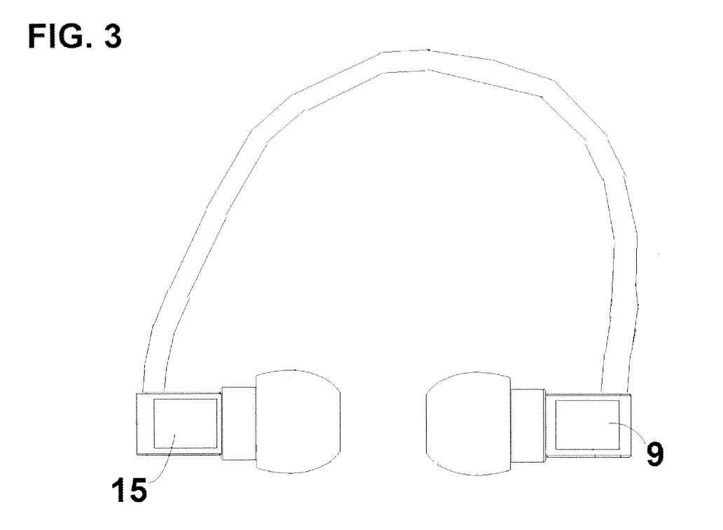

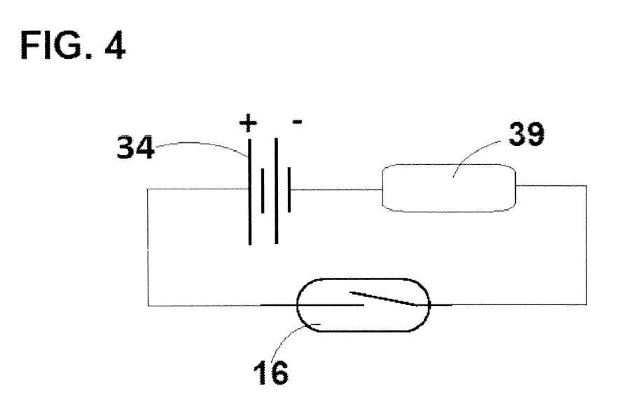

As illustrated in FIG. 3, the magnet-pad of one earphone, for instance the left earphone, can be replaced with a non-magnetic pad 15 made of a ferrous conductor such as electroplated steel. Under these conditions, it is possible to use the magnet 9 on the right earphone to perform device power on/off functions eliminating the need for an on/off push button. In order to do so the circuit board inside the housing comprises a reed switch as shown in FIG. 4. Here a partial circuit schematic inside the earphones is represented; it comprises a battery 34, a load 39 and a Reed switch 16. The Reed switch is a circuit breaker that is normally closed and that opens in the presence of a significant magnetic field. The reed switch must be physically located inside the left earphone (the one equipped with a nonmagnetic ferrous pad 15). In FIG. 3, when the right magnet-pad 9 is brought in contact with the ferrous pad 15, the Reed switch opens, powering down the entire device. At the same time, the two earphones attach to each other and can be stored within a compact volume. The ferrous pad is attracted my magnets of any polarity. State of the art reed switches come in small surface mount chip packages as small as the imperial size 0805 such as Redrock RS-A-2515 by Coto Technologies which occupies a mere 2 square millimeter.

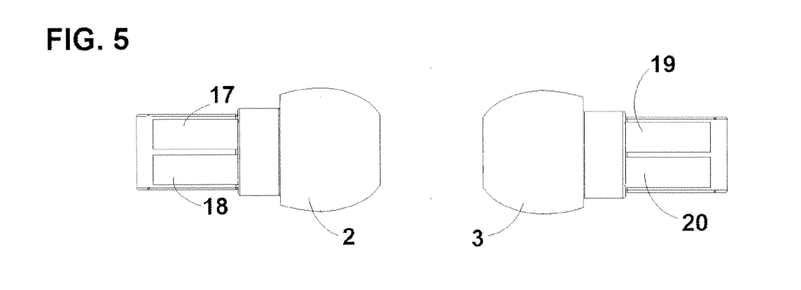

FIG. 5. depicts the wireless earphones 2 and 3 in an alternative embodiment; here the cable joining the two earphones is omitted for sake of simplicity. In the illustrated embodiment, the headset has a total of eight magnet pads, four per earphone, and FIG. 5 shows four of them marked as elements 17, 18, 19 and 20. In addition, the inner circuit board has a voltage regulator, or power management unit comprising an “enable pin.” When the enable pin is connected to the ground signal (the negative terminal of the enclosed battery), it shuts down the device; when the enable pin is connected to the battery supply voltage it powers on the device. Magnet-pads 17 and 19 are connected to the above mentioned “enable pin”; magnet-pads 18 and 20 are connected to the ground signal.

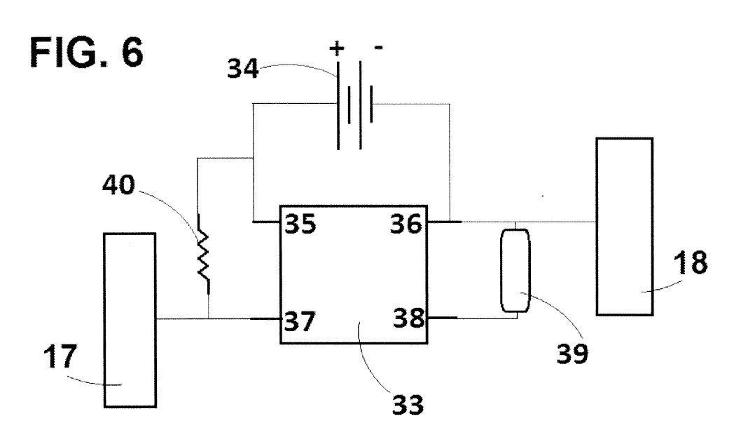

FIG. 6. illustrates a part of the circuit schematic inside the earphones. The voltage regulator is depicted as element 33, it comprises an enable pin 37, a battery supply pin 35, a ground pin 36 and an output pin 38 (providing regulated voltage to the load 39); a battery is depicted as element 34. Whenever magnet-pads 17 and 18 are shorted the enable pin 37 is driven low and the load 39 receives no power, in other words the device shuts down. Conversely, when magnet-pads 17 and 18 are separated the enable pin is driven high through a pull-up resistor 40 and the device powers up. The inventor found experimentally that a pull-up resistor in the 10 k Ohm to 100 k Ohm range provides optimal performance preventing the magnets from being accidentally shorted by contact with fingers or the ear walls even when the user's skin is wet.

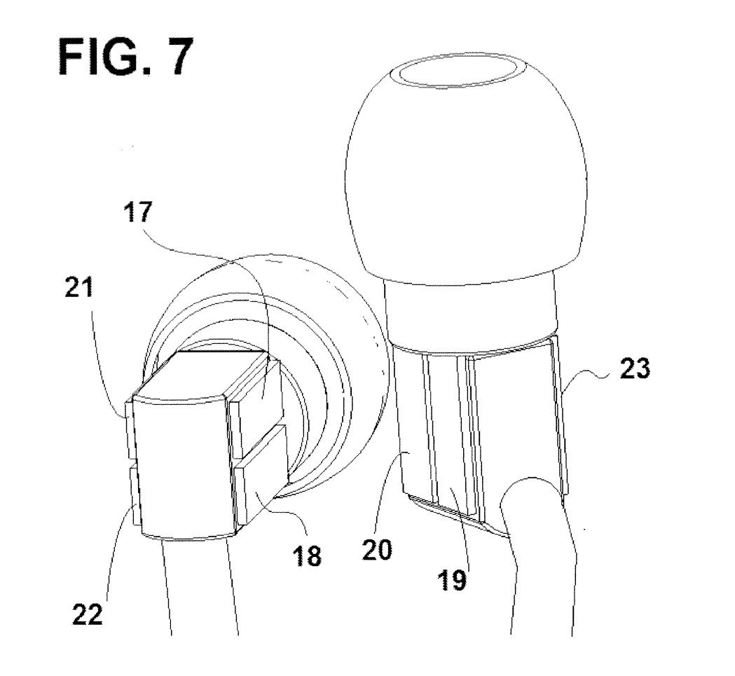

Practically, a user can short the pads by bringing the left and right earphones into physical contact in a cross geometry as shown in FIG. 7. Here the wireless stereo headset of FIG. 5 is visible. The left earphone is positioned horizontally while the right earphone is positioned vertically. When the two come into contact, the vertical magnets short the horizontal magnets, thus powering down the device. Other geometries are possible and it is possible to take advantage of the external case as ground signal thereby reducing the number of magnets. While this method of switching is more complex than the one described in the first embodiment, it does not require a reed switch IC. Additionally, this method theoretically works even if the left and right earphones are untethered, that is, if each earphone has a separate circuit board and a separate battery. In this embodiment, the portable device has a total of eight magnet-pads. In addition to the ones used for switching, there are four magnet-pads: (i) two of them (for instance elements 21 and 23 of FIG. 7) are used for battery charging, in a way similar to the one described in the first embodiment, and (ii) the two remaining magnets (including magnet 22 of FIG. 7 and another not visible in the same drawing) can be used for analog or digital data transfer in or out of the device for instance using serial asynchronous or I2C protocols.

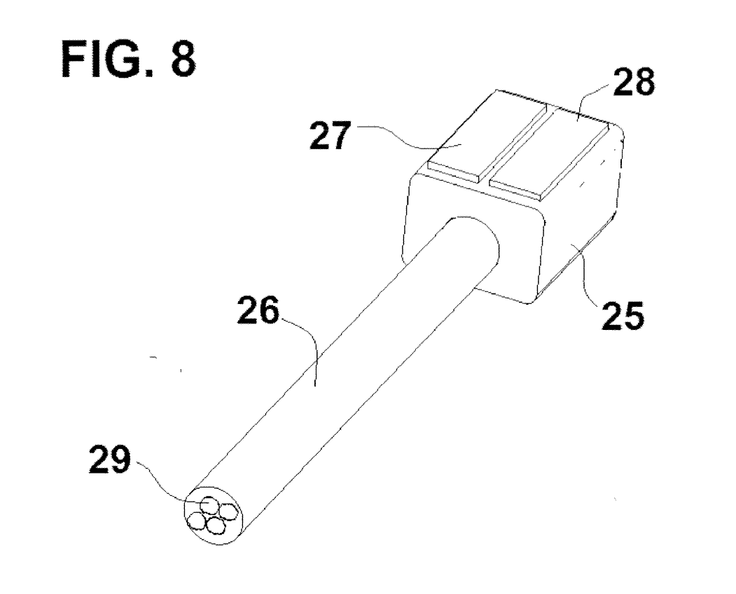

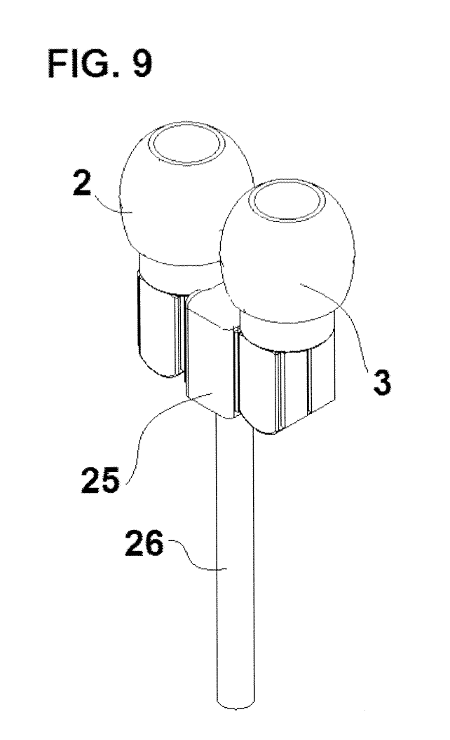

In the illustrated embodiment, the docking assembly comprises a docking head 25 with a total of four magnets whose shape and orientation match approximately those of the magnet pads located on the earphones as shown on FIG. 8. The docking head 25 is connected to a cord or cable a section of which appears as element 26. One face of the head comprises two magnet-pads 27 and 28; the opposite face (not visible) comprises two other magnet-pads of similar shape and orientation. The polarity of each magnet-pad is opposite to that of the target magnet with which it is intended to mate. The electrical signals associated with the magnets positioned on the head 25 are carried to a USB or Lightning Connector by means of four individually shielded wires depicted collectively as element 29. FIG. 9 depicts the portable earphones 2 and 3 docked to the head 25 of the docking assembly with partial view of the cord 26. The cable joining the earphones is omitted in this drawing. Neodymium magnets of grade N50—or similar—and 0.5 mm thickness are strong enough to hold the portable device firmly in place against the force of gravity.

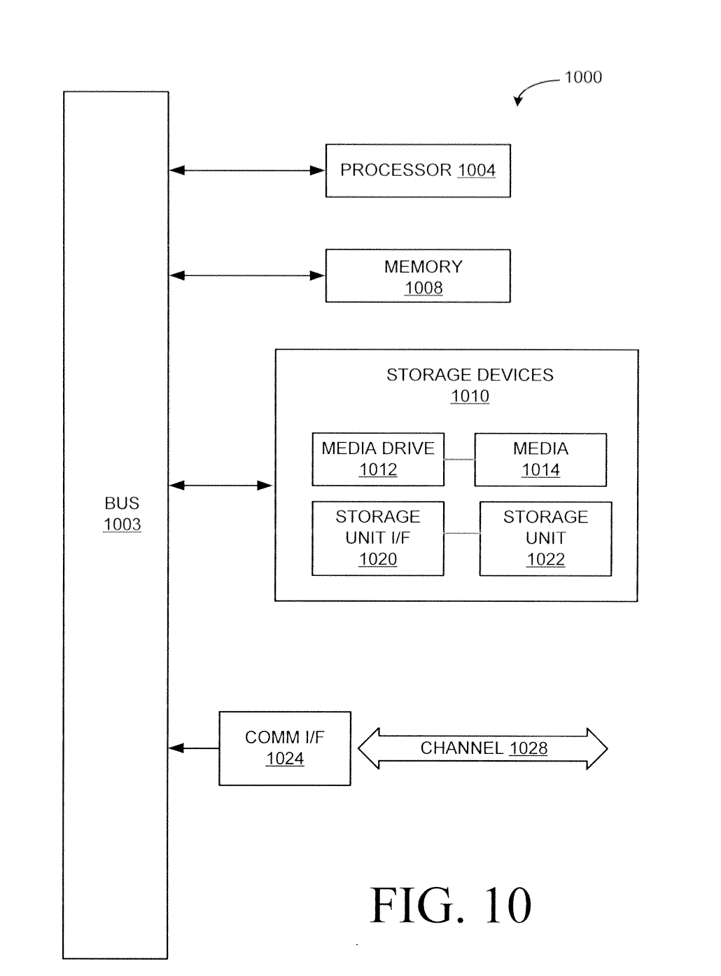

FIG. 10 illustrates an example computing module that may be used to implement various features of the systems and methods for estimating sky probes disclosed herein. As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 10. Various embodiments are described in terms of this example-computing module 1000. After reading this description, it will become apparent to a person skilled in the relevant art how to implement the application using other computing modules or architectures.

Referring now to FIG. 10, computing module 1000 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1000 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1000 might include, for example, one or more processors, controllers, control modules, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing module 1000 or to communicate externally.

Computing module 1000 might also include one or more memory modules, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing module 1000 might likewise include a read only memory (“ROM”) or other static storage device coupled to bus 1002 for storing static information and instructions for processor 1004.

The computing module 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid state drive, a magnetic tape drive, an optical disk drive, a CD, DVD, or Blu-ray drive (R or RW), or other removable or fixed media drive might be provided. Accordingly, storage media 1014 might include, for example, a hard disk, a solid state drive, magnetic tape, cartridge, optical disk, a CD, DVD, Blu-ray or other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing module 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory module) and memory slot, a PCMCIA slot and card, and other fixed or removable storage units 1022 and interfaces 1020 that allow software and data to be transferred from the storage unit 1022 to computing module 1000.

Computing module 1000 might also include a communications interface 1024. Communications interface 1024 might be used to allow software and data to be transferred between computing module 1000 and external devices. Examples of communications interface 1024 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1024 might typically be carried on signals, which can be electronic, electromagnetic (which includes optical) or other signals capable of being exchanged by a given communications interface 1024. These signals might be provided to communications interface 1024 via a channel 1028. This channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the present application as discussed herein.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An apparatus, comprising:
a portable electronic device comprising at least one low-profile magnet; and
a separate docking assembly comprising at least one magnet;
wherein a sufficient attractive magnetic force is generated between the at least one low-profile magnet and the at least one magnet to secure the portable electronic device to the docking assembly;
wherein physical contact between the at least one low-profile magnet and the at least one magnet enables flow of charge and current between the docking assembly and the portable electronic device.

2. The apparatus of claim 1, wherein the at least one low-profile magnet and the at least one magnet are electroplated with an electrically conductive layer.

3. The apparatus of claim 1, wherein the at least one low-profile magnet and the at least one magnet comprise materials having high electrical conductivity.

4. The apparatus of claim 1, wherein the portable electronic device comprises a housing that encloses at least one circuit board and at least one battery.

5. The apparatus of claim 4, wherein the at least one low-profile magnet is electrically connected to one or more terminals of the circuit board.

6. The apparatus of claim 5, wherein the docking assembly comprises a plug having a plurality of pins for connecting the assembly to a desktop computer, a mobile computing device, a battery holder or a wall outlet.

7. The apparatus of claim 6, wherein the at least one battery charges by virtue of the flow of charge and current through the at least one low-profile magnet and the at least one magnet when the portable device is connected to the docking assembly.

8. The apparatus of claim 7, wherein the portable electronic device comprises a pair of wireless stereophonic earphones.

9. The apparatus of claim 7, wherein the wireless stereophonic earphones comprise one magnet pad and one ferrous pad.

10. The apparatus of claim 9, further comprising at least one reed switch mounted on the earphone inner circuit board.

11. The apparatus of claim 10, wherein the reed switch breaks the electric flow of current that powers the portable electronic device in the presence of a sufficient magnetic field.

12. The apparatus of claim 8, wherein the earphones and the docking assembly comprise mating magnets for transferring analog or digital data between the docking assembly and the earphones.

13. The apparatus of claim 8, wherein the inner circuit board of the earphones comprises a power management unit or voltage regulator having an enable pin.

14. The apparatus of claim 13, wherein the enable pin is connected to a magnet on each earphone.

15. The apparatus of claim 14, further comprising an additional magnet on each earphone, the additional magnet connected to a negative terminal of the battery or ground, whereby shorting a magnet connected to the enable pin and a magnet connected to ground switches the wireless earphones off.

16. The apparatus of claim 7, wherein the portable electronic device comprises a wireless headset.
